(19) United States
(12) Patent Application Publication
(10) Pub. No.: US 2026/0064047 A1
(43) Pub. Date: Mar. 5, 2026

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventors: Naoki ONISHI, Kanagawa (JP); Akira SHIMODAIRA, Kanagawa (JP)

(73) Assignee: FUJIFILM Business Innovation Corp., Tokyo (JP)

(21) Appl. No.: 19/062,530

(22) Filed: Feb. 25, 2025

(30) Foreign Application Priority Data
Sep. 4, 2024 (JP) 2024-152720

(51) Int. Cl. G03G 15/16

(52) U.S. Cl. CPC G03G 15/1675; G03G 15/1605

(57) ABSTRACT

An information processing system includes at least one processor configured to: calculate a correction coefficient based on a voltage measurement value of a primary transfer unit in a first state in which voltages of same polarity are applied to the primary transfer unit and a secondary transfer unit in contact with an intermediate transfer belt of an image forming apparatus, and a voltage measurement value of the primary transfer unit in a second state in which voltages of opposite polarities are applied to the primary transfer unit and the secondary transfer unit, with a setting to make a same current as in the first state flow through the primary transfer unit; and adjust, using the correction coefficient, a transfer timing primary current to flow through the primary transfer unit when an image is transferred to an image recording medium.

### CROSS-REFERENCE TO RELATED APPLICATIONS

This application is based on and claims priority under 35 USC 119 from Japanese Patent Application No. 2024-152720 filed Sep. 4, 2024.

### BACKGROUND

### (i) Technical Field

The present disclosure relates to an information processing system and a non-transitory computer readable medium.

### (ii) Related Art

In a transfer device including a primary transfer unit and a secondary transfer unit to which transfer biases with different polarities are applied, current interference may occur between the transfer units. In such a case, a transfer failure may occur due to a current flowing from the primary transfer unit to the secondary transfer unit. The following Japanese Unexamined Patent Application Publication No. 2014-153398 discloses a transfer device including a grounded portion between a primary transfer unit and a secondary transfer unit, the grounded portion being connected to an intermediate transfer belt and the ground. With this configuration, the current interference between the transfer units is prevented.

### SUMMARY

Aspects of non-limiting embodiments of the present disclosure relate to compensation for a current flowing from a primary transfer unit to a secondary transfer unit via an intermediate transfer belt during image transfer onto an image recording medium.

Aspects of certain non-limiting embodiments of the present disclosure address the above advantages and/or other advantages not described above. However, aspects of the non-limiting exemplary embodiments are not required to address the advantages described above, and aspects of the non-limiting exemplary embodiments of the present disclosure may not address advantages described above.

According to an aspect of the present disclosure, there is provided an information processing system including at least one processor configured to: calculate a correction coefficient based on a voltage measurement value of a primary transfer unit in a first state in which voltages of same polarity are applied to the primary transfer unit and a secondary transfer unit in contact with an intermediate transfer belt of an image forming apparatus, and a voltage measurement value of the primary transfer unit in a second state in which voltages of opposite polarities are applied to the primary transfer unit and the secondary transfer unit, with a setting to make a same current as in the first state flow through the primary transfer unit; and adjust, using the correction coefficient, a transfer timing primary current to flow through the primary transfer unit when an image is transferred to an image recording medium.

### BRIEF DESCRIPTION OF THE DRAWINGS

Exemplary embodiments of the present disclosure will be described in detail based on the following figures, wherein:

FIG. 1 is a schematic view illustrating an example of an overall configuration of an information processing system of the present disclosure;

FIG. 2 is a block diagram illustrating an example of an electrical configuration of a control device in the information processing system of present disclosure;

FIG. 3 is a block diagram illustrating an example of a functional configuration of the control device in the information processing system of the present disclosure;

FIG. 4 is a table illustrating an example of a case of current adjustment processing in the information processing system of the present disclosure; and

FIGS. 5A and 5B are flowcharts illustrating an example of the current adjustment processing in the information processing system of the present disclosure.

### DETAILED DESCRIPTION

Hereinafter, an information processing system and an information processing program according to an exemplary embodiment of the present disclosure will be described with reference to the drawings. In the drawings, components denoted by the same reference numerals are the same components. However, unless otherwise specified in the specification, each component is not limited to one, and there may be a plurality of components.

In addition, description may be omitted for the same components and reference numerals in the drawings. Note that the present disclosure is not limited to the following exemplary embodiments. Various exemplary embodiments can be implemented with appropriate modifications such as omitting a configuration, replacing a configuration with a different configuration, and using one exemplary embodiment and various modifications in combination within the scope of the object of the present disclosure.

### Information Processing System

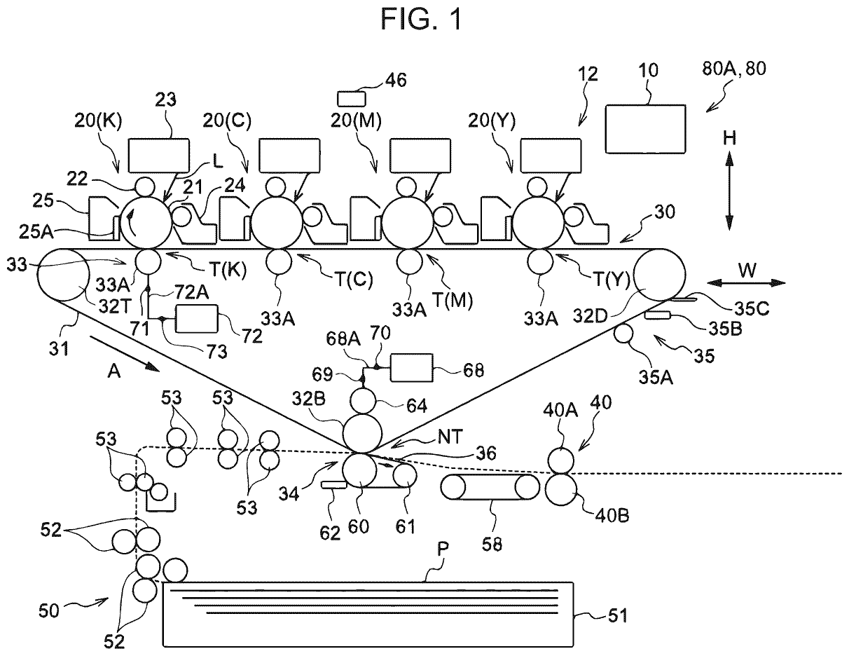

An information processing system 80 illustrated in FIG. 1 is a system constructed in an image forming apparatus 80A. The “system” in the present disclosure includes a system configured by a single apparatus. The “system” in the present disclosure further includes both a system configured by a plurality of apparatuses and a system constructed in a higher-level apparatus or system.

That is, the information processing system of the present disclosure may be constructed over a plurality of apparatuses other than the image forming apparatus 80A. For example, the information processing system 80 of the present exemplary embodiment may be constructed to include a server with which the image forming apparatus 80A can communicate, another image forming apparatus connected via a network, and the like.

Various types of processing executed by the information processing system 80 can also be executed on a cloud, an on-premises server, an edge server, an endpoint, or the like. Furthermore, the present disclosure can also be applied to a program and a program product.

### Overall Configuration of Image Forming Apparatus

FIG. 1 is a schematic view illustrating a configuration of the image forming apparatus 80A as viewed from the front side. In FIG. 1, a direction indicated by an arrow His a vertical direction, and a direction indicated by an arrow W is a horizontal direction and is an apparatus width direction.

As illustrated in FIG. 1, the image forming apparatus 80A includes an image forming unit 12 that forms an image on a sheet P as an example of an image recording medium by an electrophotographic method, a conveyance device 50 that conveys the sheet P, and a control device 10 that controls the operation of each unit of the image forming apparatus 80A. In addition, the image forming apparatus 80A includes a sensor 46 that detects temperature/humidity (that is, temperature and humidity).

### Conveyance Device 50

As illustrated in FIG. 1, the conveyance device 50 includes a container 51 in which sheets P are stored. The conveyance device 50 includes a plurality of conveyance rollers 52 and 53 that convey the sheet P from the container 51 to a secondary transfer position NT. Further, the conveyance device 50 includes a conveyer belt 58 on which the sheet P is conveyed from the secondary transfer position NT to a fixing device 40 described later.

### Image Forming Unit 12

The image forming unit 12 includes a toner image forming unit 20 that forms a toner image. Further, the image forming unit 12 includes a transfer device 30 that transfers the toner image formed by the toner image forming unit 20 onto the sheet P. The image forming unit 12 further includes the fixing device 40 that fixes the toner image transferred onto the sheet P to the sheet P by heating and pressing the toner image. The toner image forming unit 20 is an example of an image forming unit.

### Toner Image Forming Unit 20

A plurality of toner image forming units 20 are provided so as to form a toner image of each color. In the present exemplary embodiment, the toner image forming units 20 of a total of four colors of yellow (Y), magenta (M), cyan (C), and black (K) are provided. The toner image forming units 20 of the respective colors are arranged in the order of yellow (Y), magenta (M), cyan (C), and black (K) from the upstream side to the downstream side in the conveyance direction of an intermediate transfer belt 31 described later.

In FIG. 1, (Y), (M), (C), and (K) indicate components corresponding to the respective colors. In the description of the present specification, (Y), (M), (C), and (K) may be written as Y, M, C, and K, respectively, without the parentheses.

The toner image forming units 20 of the respective colors basically have the same configuration except for the toners to be used. Specifically, the toner image forming unit 20 of each color includes a photoconductor drum 21 that rotates in a clockwise direction indicated by an arrow. Further, the toner image forming unit 20 includes a charger 22 that charges the photoconductor drum 21. The toner image forming unit 20 includes an exposure device 23. The exposure device 23 exposes the photoconductor drum 21 charged by the charger 22 to form an electrostatic latent image on the photoconductor drum 21. Further, the toner image forming unit 20 of each color includes a developing device 24. The developing device 24 develops the electrostatic latent image formed on the photoconductor drum 21 by the exposure device 23 to form a toner image. The toner image forming unit 20 includes a cleaning device 25. The cleaning device 25 includes a blade 25A that removes toner remaining on the surface of the photoconductor drum 21 after the toner image has been transferred onto the transfer device 30.

The charger 22 negatively charges the surface (photosensitive layer) of the photoconductor drum 21, for example. On the surface of the photoconductor drum 21 negatively charged, a portion irradiated with exposure light L by the exposure device 23 has the positive polarity, and the electrostatic latent image is formed on the surface of the photoconductor drum 21. Then, the toner negatively and triboelectrically charged in the developing device 24 adheres to the electrostatic latent image having the positive polarity. Thus, the electrostatic latent image is developed. Thus, a toner image is formed on the surface (outer circumferential surface) of the photoconductor drum 21. The blade 25A comes into contact with the surface of the photoconductor drum 21 and scrapes off the toner remaining on the surface of the photoconductor drum 21.

### Transfer Device 30

The transfer device 30 performs primary transferring of the toner images on the photoconductor drums 21 of the respective colors onto the intermediate transfer belt 31 in a superimposed manner. Further, the transfer device 30 performs secondary transferring of the superimposed toner images to the sheet P at the secondary transfer position NT. Specifically, the transfer device 30 includes the intermediate transfer belt 31 that holds the toner images, primary transfer rollers 33A, and a secondary transfer unit 34 that includes a secondary transfer belt 36. The secondary transfer position NT is an example of a transfer position.

### Intermediate Transfer Belt 31

As illustrated in FIG. 1, the intermediate transfer belt 31 has an endless shape, and is wound around a driving roller 32D, a tension-applying roller 32T, and an opposing roller 32B to have a predetermined posture. In the first exemplary embodiment, the intermediate transfer belt 31 is positioned in the posture of an inverted obtuse triangle shape, which is elongated in the apparatus width direction in front view. Note that further rollers around which the intermediate transfer belt 31 is wound may be provided.

The driving roller 32D rotates the intermediate transfer belt 31 in a direction indicated by an arrow A using power of a motor (not illustrated). The intermediate transfer belt 31 rotates in the direction indicated by the arrow A to convey the primarily transferred toner images to the secondary transfer position NT. For example, the driving roller 32D is disposed more on the upstream side than the four primary transfer rollers 33A in the rotation direction of the intermediate transfer belt 31. The tension-applying roller 32T applies tension to the intermediate transfer belt 31.

The opposing roller 32B is a roller arranged opposite to a secondary transfer roller 60 described later. The vertex portion on the lower end side forming the obtuse angle of the intermediate transfer belt 31 in a posture of the inverted obtuse triangular shape is wound around the opposing roller 32B. The intermediate transfer belt 31 is in contact with the photoconductor drum 21 of each color from below at the upper edge portion extending in the apparatus width direction in the aforementioned posture.

A cleaning device 35 that removes the toner remaining on the intermediate transfer belt 31 is provided on the downstream side of the secondary transfer position NT and on the upstream side of a primary transfer position T(K) in the rotation direction of the intermediate transfer belt 31. For example, the cleaning device 35 includes a cleaning brush 35A, a blade 35B, and a scraper 35C. The cleaning brush 35A rotates while being in contact with the surface of the intermediate transfer belt 31 to remove the toner from the surface of the intermediate transfer belt 31. The blade 35B is disposed more on the downstream side than the cleaning brush 35A in the rotation direction of the intermediate transfer belt 31. The blade 35B comes into contact with the intermediate transfer belt 31 and scrapes off the toner on the surface of the intermediate transfer belt 31. The scraper 35C is disposed more on the downstream side than the blade 35B in the rotation direction of the intermediate transfer belt 31. The scraper 35C comes into contact with the intermediate transfer belt 31, and scrapes off the toner on the surface of the intermediate transfer belt 31 still remaining after the removal by the cleaning brush 35A and the blade 35B.

For example, the circumferential length of the intermediate transfer belt 31 is 1200 mm, the width of the intermediate transfer belt 31 in the direction orthogonal to the moving direction is 370 mm, and the thickness of the intermediate transfer belt 31 is 50 μm or more and 100 μm or less. Further, for example, the intermediate transfer belt 31 has a configuration in which carbon is dispersed in polyimide resin.

### Primary Transfer Unit 33

As illustrated in FIG. 1, a primary transfer unit 33 includes the primary transfer roller 33A. The primary transfer roller 33A is a roller that transfer the toner images on the photoconductor drums 21 onto the intermediate transfer belt 31. The primary transfer roller 33A is disposed on the inner side of the intermediate transfer belt 31. Each primary transfer roller 33A is disposed opposite to the photoconductor drum 21 of the corresponding color with the intermediate transfer belt 31 interposed therebetween. A variable power supply 72 is connected to the primary transfer roller 33A. The variable power supply 72 is a power supply capable of varying DC constant voltage and constant current. A current measuring element 71 and a voltage measuring element 73 are connected to a wire 72A between the primary transfer roller 33A and the variable power supply 72. The current measuring element 71 measures a current in the primary transfer unit 33. The voltage measuring element 73 measures a voltage in the primary transfer unit 33.

In FIG. 1, the variable power supply 72, the wire 72A, the current measuring element 71, and the voltage measuring element 73 are connected only to the primary transfer roller 33A closest to the secondary transfer unit 34. The variable power supply 72, the wire 72A, the current measuring element 71, and the voltage measuring element 73 connected to the other transfer rollers 33A are not illustrated.

The variable power supply 72 applies a primary transfer voltage of an opposite polarity to the toner polarity, to the primary transfer roller 33A. Specifically, since the toner is negatively and triboelectrically charged, a positive primary transfer voltage is applied to the primary transfer roller 33A. When the primary transfer voltage is applied, the toner image formed on the photoconductor drum 21 is transferred onto the intermediate transfer belt 31. The toner image is transferred onto the intermediate transfer belt 31 at the primary transfer position T between the photoconductor drum 21 and the primary transfer roller 33A.

### Secondary Transfer Unit 34

The secondary transfer unit 34 includes the secondary transfer belt 36, as well as the secondary transfer roller 60 and a driven roller 61 that rotatably support the secondary transfer belt 36. The secondary transfer unit 34 includes the opposing roller 32B. The opposing roller 32B is arranged opposite to the secondary transfer roller 60 with the intermediate transfer belt 31 and the secondary transfer belt 36 interposed therebetween. In addition, the secondary transfer unit 34 includes a contact roller 64 that supplies power to the opposing roller 32B by coming into contact with the opposing roller 32B. Further, the secondary transfer unit 34 includes a cleaning device 62 that removes the toner on the surface of the secondary transfer belt 36. In the secondary transfer unit 34, the contact roller 64 applies a transfer bias between the opposing roller 32B and the secondary transfer roller 60. Thus, a transfer electric field is formed. Due to the transfer electric field, the toner images superimposed on the intermediate transfer belt 31 are transferred onto the sheet P conveyed between the intermediate transfer belt 31 and the secondary transfer belt 36.

The secondary transfer belt 36 has an endless shape and is wound around the secondary transfer roller 60 and the driven roller 61. The secondary transfer roller 60 is rotationally driven by a motor (not illustrated). The driven roller 61 is driven as the secondary transfer belt 36 moves in a circular motion.

For example, the secondary transfer belt 36 includes a layer in which carbon is dispersed in an elastomer such as polyurethane, and a surface layer formed of a fluororesin or the like.

The secondary transfer roller 60 is disposed with the intermediate transfer belt 31 and the secondary transfer belt 36 interposed between the secondary transfer roller 60 and the opposing roller 32B. Further, the secondary transfer belt 36 and the intermediate transfer belt 31 are in contact with each other with a predetermined load. A portion between the secondary transfer belt 36 and the intermediate transfer belt 31, which are thus in contact with each other, is the secondary transfer position NT. The sheet P is supplied from the container 51 to the secondary transfer position NT at an appropriate timing.

For example, the secondary transfer roller 60 is formed of a foam roller in which a conductive resin is dispersed. For example, the driven roller 61 is formed of a metal roller.

As an example, the opposing roller 32B has a configuration in which a conductive material such as carbon is dispersed in a foam roller.

A variable power supply 68 is connected to the contact roller 64. The variable power supply 68 is a power supply capable of varying DC constant voltage and constant current. Although not illustrated in the drawings, the variable power supply 68 includes a switching unit that switches between and supplies a positive voltage and a negative voltage. The variable power supply 68 can supply a positive voltage and a negative voltage to the contact roller 64 by switching between the positive and negative voltages using the switching unit. A current measuring element 69 and a voltage measuring element 70 are connected to a wire 68A between the contact roller 64 and the variable power supply 68. The current measuring element 69 measures a current in the secondary transfer unit 34. The voltage measuring element 70 measures a voltage in the secondary transfer unit 34.

In the image forming apparatus 80A, the variable power supply 68 applies a transfer bias to the opposing roller 32B via the contact roller 64.

For example, when the toner image on the surface of the intermediate transfer belt 31 is transferred onto the sheet P, the variable power supply 68 applies a negative voltage to the opposing roller 32B via the contact roller 64. This results in a potential difference between the opposing roller 32B and the secondary transfer roller 60. That is, when a negative voltage is applied to the opposing roller 32B, a secondary transfer voltage (positive voltage) having a polarity opposite to the toner polarity is indirectly applied to the secondary transfer roller 60 serving as a counter electrode of the opposing roller 32B. As a result, a negative toner image is transferred from the intermediate transfer belt 31 onto the sheet P passing through the secondary transfer position NT.

In the secondary transfer unit 34, the variable power supply 68 applies a transfer bias to the opposing roller 32B under constant current control or constant voltage control. For example, the output of the transfer bias is determined according to the temperature/humidity detected by the sensor 46 and the type of the sheet P. Further, the output of the transfer bias is determined by the width of the sheet P in the direction orthogonal to the conveyance direction.

When the passage of the sheet P does not occur, the variable power supply 68 applies a bias having a polarity opposite to that during transfer to the opposing roller 32B. For example, in the secondary transfer unit 34, the load at the pressing portion between the opposing roller 32B and the secondary transfer roller 60 is 30 N or more and 200 N or less. The load at the pressing portion is determined by the type of the sheet P and the temperature/humidity.

For example, when the toner is held on the intermediate transfer belt 31 at the time when the toner on the intermediate transfer belt 31 passes through the secondary transfer position NT, the variable power supply 68 applies a positive voltage to the opposing roller 32B via the contact roller 64. This results in a potential difference between the opposing roller 32B and the secondary transfer roller 60. That is, when the positive voltage is applied to the opposing roller 32B, a non-transfer voltage (negative voltage) having the same polarity as the toner polarity is indirectly applied to the secondary transfer roller 60 serving as a counter electrode of the opposing roller 32B. Accordingly, the toner passing through the secondary transfer position NT receives a repulsive force from the secondary transfer roller 60 to be held on the intermediate transfer belt 31.

In the image forming apparatus 80A, the variable power supply 68 applies a transfer bias to the opposing roller 32B under the constant current control. When the image forming operation starts, the intermediate transfer belt 31 and the secondary transfer belt 36 move in a circular motion. Then, a standard current value corresponding to a process speed, which is an image forming speed, is applied to the contact roller 64. The current flows along the surface of the opposing roller 32B, and the transfer bias is applied to the sheet P via the intermediate transfer belt 31.

The voltage measuring element 70 measures a member partial pressure Vm applied to a member before the sheet P passes through the secondary transfer unit 34. The voltage measuring element 70 measures a sheet partial pressure Vp, which is an example of a recording medium partial pressure at the time when the sheet P passes through the secondary transfer unit 34.

The cleaning device 62 is a blade that comes into contact with the secondary transfer belt 36 and removes the toner adhering to the secondary transfer belt 36. For example, the blade forming the cleaning device 62 is formed of polyurethane or the like.

### Fixing Device 40

The fixing device 40 includes a heating roller 40A and a pressure roller 40B pressed against the heating roller 40A. The sheet Ponto which the toner image has been transferred passes through the nip portion between the heating roller 40A and the pressure roller 40B. As a result, the toner image is fixed to the sheet P.

### Sensor 46

The sensor 46 detects temperature/humidity (that is, temperature and humidity). Information on the temperature and the humidity detected by sensor 46 is output to the control device 10.

### Electrical Configuration of Control Device

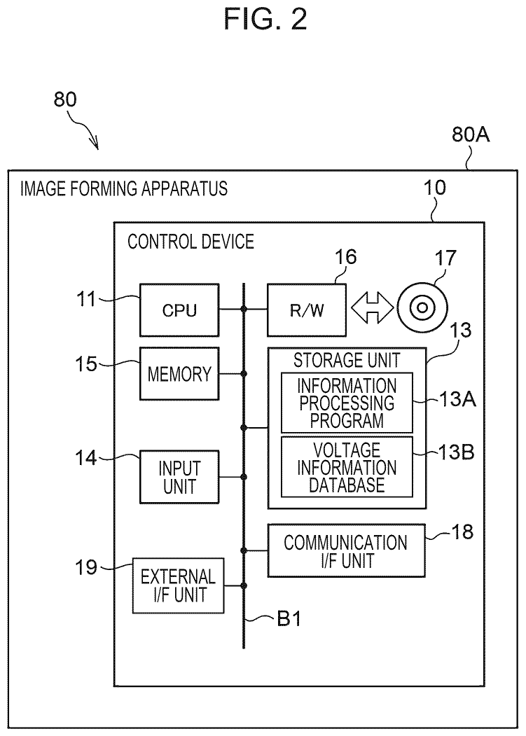

As illustrated in FIG. 2, the control device 10 includes a central processing unit (CPU, processor) 11, a memory 15 as a temporary storage area, a nonvolatile storage unit 13, an input unit 14, a medium read/write device (R/W) 16, a communication interface (I/F) unit 18, and an external I/F unit 19. The CPU 11, the memory 15, the storage unit 13, the input unit 14, the medium read/write device 16, the communication I/F unit 18, and the external I/F unit 19 are connected to each other via a bus B1.

The CPU 11 controls the entire operation of the control device 10.

The storage unit 13 is realized by a hard disk drive (HDD), a solid state drive (SSD), a flash memory, or the like. The storage unit 13 that is a storage medium stores an information processing program 13A. The information processing program 13A is stored in the storage unit 13 when a recording medium 17 in which the information processing program 13A is written is set in the medium read/write device 16 and the medium read/write device 16 reads the information processing program 13A from the recording medium 17. The CPU 11 reads the information processing program 13A from the storage unit 13, loads the information processing program 13A onto the memory 15, and sequentially executes the processes included in the information processing program 13A. The storage unit 13 stores a voltage information database 13B, which will be described later.

The input unit 14 is an interface on which a user can perform an operation of inputting a job to be executed by the image forming apparatus 80A. The input unit 14 includes a display unit and an operation unit.

The display unit is a display screen configured by combining, for example, a touch panel with a liquid crystal display, an organic EL display, or the like. On the display unit, an image or the like is displayed in response to a touch operation by the user, processing of the image forming apparatus 80A, or the like. The operation unit includes an operation key, an operation button, a power button, and the like, which are provided in the image forming apparatus 80A.

The user can designate job content or input job execution instructions to the image forming apparatus 80A through a touch operation on the display unit. The input operation by the user may be performed via the operation unit.

The medium read/write device 16 reads information written in the recording medium 17 and writes information to the recording medium 17. The communication I/F unit 18 is, for example, an interface for communicably connecting a server provided outside the control device 10 or various terminals used by the user to the control device. For the communication I/F unit 18, for example, a communication standard such as Wi-Fi (registered trademark), Bluetooth (registered trademark), or a local area network (LAN) is used.

### Functional Configuration of Control Device

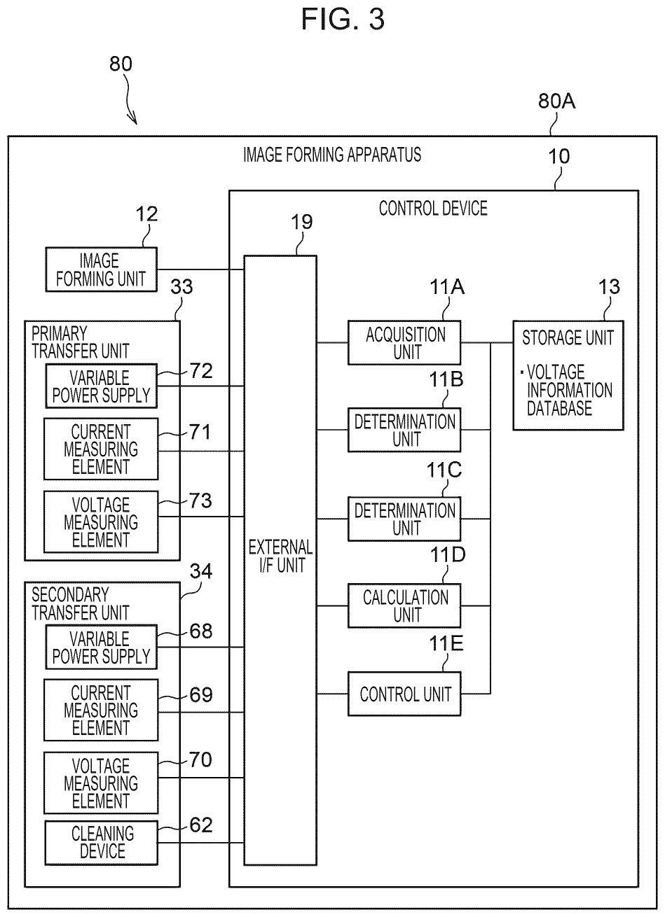

Next, a functional configuration of the control device 10 according to the present exemplary embodiment will be described with reference to FIG. 3. As illustrated in FIG. 3, the control device 10 includes an acquisition unit 11A, a determination unit 11B, a setting unit 11C, a calculation unit 11D, and a control unit 11E. The CPU 11 of the control device 10 functions as the acquisition unit 11A, the determination unit 11B, the setting unit 11C, the calculation unit 11D, and the control unit 11E by executing the information processing program 13A.

### Acquisition Unit

The acquisition unit 11A acquires a job execution instruction input by the user via the input unit 14. For example, the acquisition unit 11A acquires an instruction to execute transferring (print execution instruction) of an image onto an image recording medium. When the acquisition unit 11A receives an instruction to execute a subsequent job during the execution of the job, the subsequent job is stored in the storage unit 13 as execution-standby job information.

The acquisition unit 11A acquires the values of the current and the voltage respectively measured by the current measuring element 71 and the voltage measuring element 73 of the primary transfer unit 33. The acquisition unit 11A also acquires the value of the current measured by the current measuring element 69 of the secondary transfer unit 34. Further, the acquisition unit 11A acquires the value of the voltage measured by the voltage measuring element 70 of the secondary transfer unit 34.

### Control Unit

The control unit 11E controls various functions of the image forming apparatus 80A, such as that of the image forming unit 12 in the image forming apparatus 80A.

The control unit 11E controls the output of the primary transfer unit 33 to the variable power supply 72. Under the control of the control unit 11E, a positive primary transfer voltage is applied to the primary transfer roller 33A under constant current control. In the present specification, the current flowing through the primary transfer unit 33 at the time of image transfer onto the sheet P is referred to as “transfer timing primary current”. A voltage applied to the primary transfer roller 33A when the transfer timing primary current is caused to flow through the primary transfer unit 33 is referred to as “transfer timing primary voltage”.

The control unit 11E controls the output of the secondary transfer unit 34 to the variable power supply 68. Under the control of the control unit 11E, a negative secondary transfer voltage is applied to the opposing roller 32B under the constant current control. Under the control of the control unit 11E, a positive secondary transfer voltage is applied to the opposing roller 32B under the constant current control.

When the toner image on the intermediate transfer belt 31 is transferred onto the sheet P, the control unit 11E applies a negative secondary transfer voltage to the opposing roller 32B. In the present specification, a current flowing through the secondary transfer unit 34 during image transfer onto the sheet P is referred to as “transfer timing secondary current”. A voltage applied to the opposing roller 32B when the transfer timing secondary current flows through the secondary transfer unit 34 is referred to as “transfer timing secondary voltage”.

When the toner adhering to the secondary transfer belt 36 is removed, the control unit 11E applies a positive secondary transfer voltage to the opposing roller 32B. When calculating a correction coefficient (to be described in detail later) for correcting the transfer timing primary current, the control unit 11E applies a positive secondary transfer voltage to the opposing roller 32B.

A state in which voltages of the same polarity are applied to the primary transfer unit 33 and the secondary transfer unit 34 that are in contact with the intermediate transfer belt 31 is referred to as “first state”. The first state is, for example, a state in which a current having a positive polarity flows through the primary transfer unit 33 and a current having a positive polarity flows through the secondary transfer unit 34.

A state in which voltages of opposite polarities are applied to the primary transfer unit and the secondary transfer unit with the same current as that in the first state is set to flow through the primary transfer unit 33 is referred to as “second state”. The second state is, for example, a state in which a current having a positive polarity flows through the primary transfer unit 33 and a current having a negative polarity flows through the secondary transfer unit 34. The “the same current as that in the first state is set to flow through the primary transfer unit 33” means that the current setting of the primary transfer unit 33 is maintained when the state transitions from the first state to the second state.

Furthermore, the control unit 11E adjusts the “transfer timing primary current”. Specifically, the control unit 11E adjusts the output of the primary transfer unit 33 to the variable power supply 72, and makes a “corrected transfer timing primary current” flow to the primary transfer unit 33 by using the “correction coefficient” to be described later.

### Determination Unit

The determination unit 11B determines whether the voltage of the primary transfer unit 33 acquired by the acquisition unit 11A (that is, the transfer timing primary voltage) is equal to or higher than a predetermined “reference voltage” when the control unit 11E makes the “transfer timing primary current” flow through the primary transfer unit 33 and makes the “transfer timing secondary current” flow through the secondary transfer unit 34. The reference voltage is, for example, 1000 [V]. This reference voltage can be preset and is stored in the voltage information database 13B.

The determination unit 11B determines whether a difference between the predetermined “reference voltage” and the voltage of the primary transfer unit 33 acquired by the acquisition unit 11A (that is, the transfer timing primary voltage) does not exceed a threshold when the control unit 11E makes the “transfer timing primary current” flow through the primary transfer unit 33 and makes the “transfer timing secondary current” flow through the secondary transfer unit 34. The threshold is, for example, 500 [V]. This threshold can be preset and is stored in the voltage information database 13B.

### Calculation Unit

The calculation unit 11D calculates the correction coefficient based on the voltage measurement value of the primary transfer unit 33 in the first state and the voltage measurement value of the primary transfer unit 33 in the second state. A method of calculating the correction coefficient will be described later.

The calculation unit 11D calculates the correction coefficient based on the voltage measurement value of the primary transfer unit 33 (primary transfer position T(K)) closest to the secondary transfer unit 34 on the upstream side in the rotation direction of the intermediate transfer belt 31.

### Types of Method of Correcting Transfer Timing Primary Current

Types of the method of correcting the transfer timing primary current will be described.

### Case 1

### Initial State

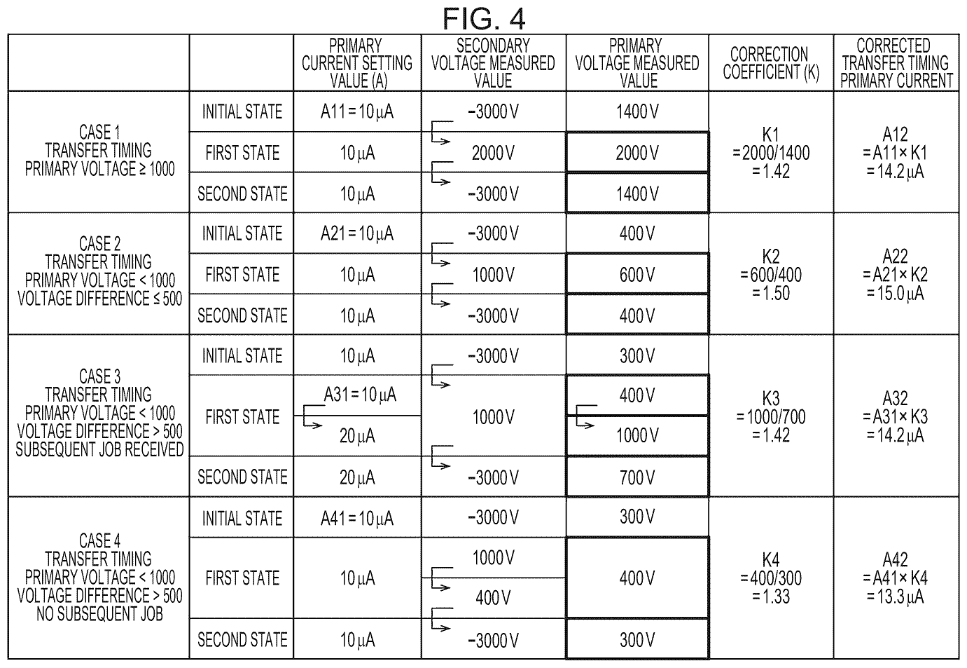

In response to the input of a print job involving image transfer onto a sheet P to the image forming apparatus 80A, the control unit 11E makes the transfer timing primary current flow through the primary transfer unit 33. In the example illustrated in case 1 of FIG. 4, the transfer timing primary current is 10 μA. Further, the control unit 11E makes the transfer timing secondary current flow through the secondary transfer unit 34. At this time, a positive voltage is applied to the primary transfer unit 33, and a negative voltage is applied to the secondary transfer unit 34. This state is referred to as initial state.

The acquisition unit 11A acquires the primary voltage (transfer timing primary voltage) measured by the voltage measuring element 73 as appropriate. Furthermore, the acquisition unit 11A acquires the secondary voltage (transfer timing secondary voltage) measured by the voltage measuring element 70 as appropriate.

In the example illustrated in Case 1 of FIG. 4, with the predetermined reference voltage assumed to be 1000 V, the primary voltage in the initial state is 1400 V and is equal to or higher than the reference voltage. This case where the voltage (transfer timing primary voltage) at the time when the transfer timing primary current flows through the primary transfer unit 33 is equal to or higher than the predetermined reference voltage is defined as Case 1. In the following description, the reference voltage is assumed to be 1000 V.

### First State

Next, the control unit 11E adjusts the current to flow through the secondary transfer unit 34. As a result, a current having the same polarity (positive polarity) as the primary transfer unit 33 and causing application of the voltage equal to that applied to the primary transfer unit 33 is caused to flow through the secondary transfer unit 34. In this case, current interference is less likely to occur between the primary transfer unit 33 and the secondary transfer unit 34 than in the case where these voltages are different. In the example illustrated in Case 1 of FIG. 4, a current causing application of 2000 V, as a voltage equal to that applied to the primary transfer unit 33, is caused to flow through the secondary transfer unit 34. Note that “voltage equal to” does not need to be exactly the same, and may include a setting tolerance of about 10%.

### Second State

Next, the control unit 11E adjusts the current to flow through the secondary transfer unit 34. As a result, a current (transfer timing secondary current) causing application of the transfer timing secondary voltage, which is a voltage opposite in polarity (negative polarity) to the primary transfer unit 33, flows through the secondary transfer unit 34. The same current as that in the first state is set to flow through the primary transfer unit 33. At this time, the primary transfer unit 33 and the secondary transfer unit 34 differ in voltage. Therefore, the current interference occurs between the primary transfer unit 33 and the secondary transfer unit 34.

In the example illustrated in Case 1 of FIG. 4, the current interference occurs when −3000 V as the transfer timing secondary voltage is applied to the secondary transfer unit 34. As a result, the voltage of the primary transfer unit 33 becomes 1400 V.

### Calculation of Correction Coefficient

Next, the calculation unit 11D calculates the correction coefficient based on the voltage measurement value (2000 V) of the primary transfer unit 33 in the first state and the voltage measurement value (1400 V) of the primary transfer unit 33 in the second state. Specifically, the voltage measurement value of the primary transfer unit 33 in the first state is divided by the voltage measurement value of the primary transfer unit 33 in the second state. Thus, a correction coefficient K1 is calculated as follows.

$$K 1 = 2 \; 000 / 1400 = 1.42$$

### Adjustment of Transfer Timing Primary Current

Next, the control unit 11E adjusts the transfer timing primary current using the calculated correction coefficient. Specifically, a current (corrected transfer timing primary current A12) obtained by multiplying a primary current setting value (initial current A11) flowing in the initial state by the correction coefficient K1 is caused to flow through the primary transfer unit 33.

$$A 12 = A 11 \times K 1 = 10 μA \times 1.42 = 14.2 μA \qquad ( Case 2 )$$

### Initial State

In the example illustrated in Case 2 of FIG. 4, the primary voltage in the initial state is 400 V, which is lower than the reference voltage (1000 V).

### First State

The control unit 11E adjusts the current to flow through the secondary transfer unit 34. As a result, the reference voltage having the same polarity (positive polarity) as the primary transfer unit 33 is applied to the secondary transfer unit 34.

In the example illustrated in Case 2 of FIG. 4, a current causing application of the reference voltage is caused to flow through the secondary transfer unit 34. At this time, the voltage of the primary transfer unit 33 is, for example, 600 V. In this case, the difference between the reference voltage (1000 V) and the voltage of the primary transfer unit 33 is 400 V. For example, a threshold of the difference between the reference voltage and the voltage of the primary transfer unit is 500 V. In this case, in Case 2, the difference between the reference voltage and the voltage of the primary transfer unit 33 is 400 V and thus does not exceed the threshold.

As described above, in Case 2, which is a case different from Case 1, when the current causing application of the reference voltage is caused to flow through the secondary transfer unit 34 and the transfer timing primary current is caused to flow through the primary transfer unit, the difference between the reference voltage and the voltage of the primary transfer unit does not exceed the threshold.

### Second State

Next, the control unit 11E adjusts the current to flow through the secondary transfer unit 34. This results in application of the transfer timing secondary voltage, which is a voltage of an opposite polarity (negative polarity) to that applied to the primary transfer unit 33, to the secondary transfer unit 34. The same current as that in the first state is set to flow through the primary transfer unit 33. At this time, the primary transfer unit 33 and the secondary transfer unit 34 differ in voltage. Therefore, the current interference occurs between the primary transfer unit 33 and the secondary transfer unit 34.

In the example illustrated in Case 2 of FIG. 4, when −3000 V as the transfer timing secondary voltage is applied to the secondary transfer unit 34, the current interference occurs. As a result, the voltage of the primary transfer unit 33 becomes 400 V.

### Calculation of Correction Coefficient

Next, the calculation unit 11D calculates the correction coefficient based on the voltage measurement value (600 V) of the primary transfer unit 33 in the first state and the voltage measurement value (400 V) of the primary transfer unit 33 in the second state. Specifically, the voltage measurement value of the primary transfer unit 33 in the first state is divided by the voltage measurement value of the primary transfer unit 33 in the second state. Thus, a correction coefficient K2 is calculated as follows.

$$K 2 = 600 / 400 = 1.5$$

### Adjustment of Transfer Timing Primary Current

Next, the control unit 11E adjusts the transfer timing primary current using the calculated correction coefficient. Specifically, a current (corrected transfer timing primary current A22) obtained by multiplying a primary current setting value (initial current A21) flowing in the initial state by the correction coefficient K2 is caused to flow through the primary transfer unit 33.

$$A 22 = A 21 \times K 2 = 10 μA \times 1.5 = 15. μA \qquad ( Case 3 )$$

### Initial State

In the example illustrated in Case 3 of FIG. 4, the primary voltage in the initial state is 300 V, which is lower than the reference voltage (1000 V).

### First State

The control unit 11E adjusts the current to flow through the secondary transfer unit 34, and makes a current having the same polarity (positive polarity) as the primary transfer unit 33 and causing application of the reference voltage flow through the secondary transfer unit 34.

In the example illustrated in Case 3 of FIG. 4, a current causing application of the reference voltage is caused to flow through the secondary transfer unit 34. At this time, the voltage of the primary transfer unit 33 is, for example, 400 V. In this case, the difference between the reference voltage (1000 V) and the voltage of the primary transfer unit 33 is 600 V. In this Case 3, the difference between the reference voltage and the voltage of the primary transfer unit 33 is 600 V exceeding the threshold (500 V).

As described above, in Case 3 or Case 4, which is a case different from Case 1, when the current causing application of the reference voltage is caused to flow through the secondary transfer unit 34 and the transfer timing primary current is caused to flow through the primary transfer unit, the difference between the reference voltage and the voltage of the primary transfer unit exceeds the threshold. The threshold can be determined in advance.

Furthermore, in Case 3, a subsequent job involving image transfer onto the sheet P has been received by the acquisition unit 11A. In addition, as will be described later, in Case 4, a subsequent job involving image transfer onto the sheet P has not been received by the acquisition unit 11A.

In Case 3, in the first state, the control unit 11E adjusts the current to flow through the primary transfer unit 33, and makes a current having the voltage equal to that applied to the secondary transfer unit 34 and causing application of the reference voltage (1000 V) flow through the primary transfer unit 33. For example, in the example illustrated in Case 3 of FIG. 4, the current flowing through the primary transfer unit 33 is assumed to be 20 μA. In this case, current interference is less likely to occur between the primary transfer unit 33 and the secondary transfer unit 34 than in the case where these voltages are different.

### Second State

Next, the control unit 11E adjusts the current to flow through the secondary transfer unit 34. This results in application of the transfer timing secondary voltage, which is a voltage of an opposite polarity (negative polarity) to that applied to the primary transfer unit 33, to the secondary transfer unit 34. The same current as that in the first state after the current adjustment is set to flow through the primary transfer unit 33. At this time, the primary transfer unit 33 and the secondary transfer unit 34 differ in voltage. Therefore, the current interference occurs between the primary transfer unit 33 and the secondary transfer unit 34.

In the example illustrated in Case 3 of FIG. 4, when -3000 V as the transfer timing secondary voltage is applied to the secondary transfer unit 34, the current interference occurs. As a result, the voltage of the primary transfer unit 33 becomes 700 V.

### Calculation of Correction Coefficient

Next, the calculation unit 11D calculates the correction coefficient based on the voltage measurement value (1000 V) of the primary transfer unit 33 in the first state and the voltage measurement value (700 V) of the primary transfer unit 33 in the second state. Specifically, the voltage measurement value of the primary transfer unit 33 in the first state is divided by the voltage measurement value of the primary transfer unit 33 in the second state. Thus, a correction coefficient K3 is calculated as follows.

$$K 3 = 1 \; 000 / 700 = 1.42$$

### Adjustment of Transfer Timing Primary Current

Next, the control unit 11E adjusts the transfer timing primary current using the calculated correction coefficient. Specifically, a current (corrected transfer timing primary current A32) obtained by multiplying a primary current setting value (initial current A31) flowing in the initial state by the correction coefficient K3 is caused to flow through the primary transfer unit 33.

$$A 32 = A 31 \times K 3 = 10 μA \times 1.42 = 14.2 μA \qquad ( Case 4 )$$

### Initial State

In the example illustrated in Case 4 of FIG. 4, the primary voltage in the initial state is 300 V, which is lower than the reference voltage (1000 V).

### First State

The control unit 11E adjusts the current to flow through the secondary transfer unit 34. As a result, a current having the same polarity (positive polarity) as the primary transfer unit 33 and causing application of the reference voltage is caused to flow through the secondary transfer unit 34.

In the example illustrated in Case 4 of FIG. 4, a current causing application of the reference voltage is caused to flow through the secondary transfer unit 34. At this time, the voltage of the primary transfer unit 33 is, for example, 400 V. In this case, the difference between the reference voltage (1000 V) and the voltage of the primary transfer unit 33 is 600V. In this Case 4, the difference between the reference voltage and the voltage of the primary transfer unit 33 is 600 V exceeding the threshold (500 V).

In Case 4, in the first state, the control unit 11E adjusts the current to flow through the secondary transfer unit 34, and makes a current causing application of a voltage (400 V) equal to that applied to the primary transfer unit 33 flow through the secondary transfer unit 34. In this case, current interference is less likely to occur between the primary transfer unit 33 and the secondary transfer unit 34 than in the case where these voltages are different.

### Second State

Next, the control unit 11E adjusts the current to flow through the secondary transfer unit 34. This results in application of the transfer timing secondary voltage, which is a voltage of an opposite polarity (negative polarity) to that applied to the primary transfer unit 33, to the secondary transfer unit 34. The same current as that in the first state after the current adjustment is set to flow through the primary transfer unit 33. At this time, the primary transfer unit 33 and the secondary transfer unit 34 differ in voltage. Therefore, the current interference occurs between the primary transfer unit 33 and the secondary transfer unit 34.

In the example illustrated in Case 4 of FIG. 4, when −3000 V as the transfer timing secondary voltage is applied to the secondary transfer unit 34, the current interference occurs. As a result, the voltage of the primary transfer unit 33 becomes 300 V.

### Calculation of Correction Coefficient

Next, the calculation unit 11D calculates the correction coefficient based on the voltage measurement value (400 V) of the primary transfer unit 33 in the first state and the voltage measurement value (300 V) of the primary transfer unit 33 in the second state. Specifically, the voltage measurement value of the primary transfer unit 33 in the first state is divided by the voltage measurement value of the primary transfer unit 33 in the second state. Thus, a correction coefficient K4 is calculated as follows.

$$K 4 = 400 / 300 = 1.33$$

### Cleaning

In Case 4, after the correction coefficient is calculated, the control unit 11E makes a current causing application of a voltage equal to or higher than the reference voltage of 1000 V flow through the secondary transfer unit 34. Then, the cleaning device 62 is controlled to perform cleaning to remove the toner adhering to the secondary transfer belt 36.

### Adjustment of Transfer Timing Primary Current

Next, the control unit 11E adjusts the transfer timing primary current using the calculated correction coefficient. Specifically, a current (corrected transfer timing primary current A42) obtained by multiplying a primary current setting value (initial current A41) flowing in the initial state by the correction coefficient K4 is caused to flow through the primary transfer unit 33.

$$A 42 = A 41 \times K 4 = 10 μA \times 1.33 = 13.3 μA$$

### Matters Common Among Cases

In Cases 1, 3, and 4 described above, in order to calculate the correction coefficient, in the first state, a current for applying an equal voltage (2000 V in Case 1, 1000 V in Case 3, and 400 V in Case 4) to the primary transfer unit 33 and the secondary transfer unit 34 is caused to flow.

In Cases 1, 2, and 4 described above, in order to calculate the correction coefficient, the transfer timing primary current (10 uA) before the adjustment is caused to flow through the primary transfer unit 33 in the first state and in the second state.

In Cases 1 and 4 described above, in order to calculate the correction coefficient, in the first state, a current for applying a voltage (2000 V in case 1 and 400 V in case 4) equal to that applied to the primary transfer unit 33 is caused to flow through the secondary transfer unit 34. That is, the voltage applied to the secondary transfer unit 34 is set to be the same with the voltage applied to the primary transfer unit 33.

In Case 3, in the first state, the voltage applied to the primary transfer unit 33 is set to be the same as the voltage (1000 V) applied to the secondary transfer unit 34. In Case 2, in the first state, the voltage applied to the primary transfer unit 33 and the voltage applied to the secondary transfer unit 34 are not set to be the same.

### Current Adjustment Processing

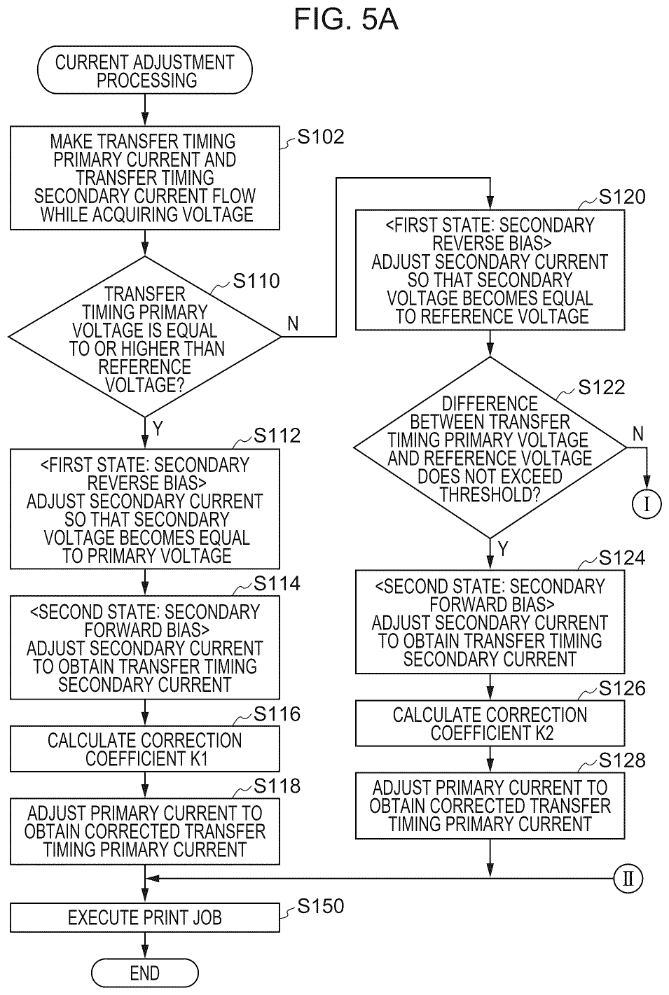

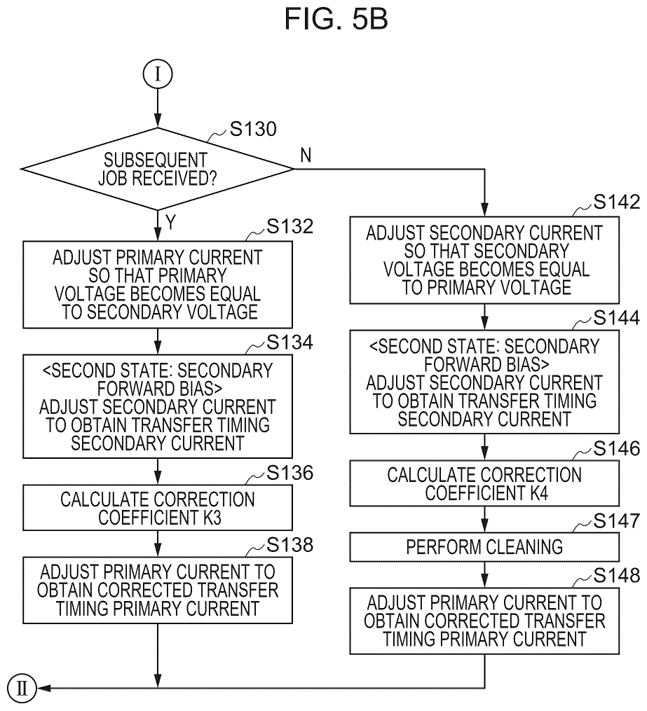

The CPU 11 of the control device 10 in the image forming apparatus 80A starts “current adjustment processing” illustrated in FIGS. 5A and 5B upon receiving a job involving image transfer onto the sheet P.

When the current adjustment processing is executed, in step S102, the CPU 11 makes the transfer timing primary current flow through the primary transfer unit 33 and makes the transfer timing secondary current flow through the secondary transfer unit 34 while acquiring the voltages of the primary transfer unit 33 and the secondary transfer unit 34. At this time, the CPU 11 acquires the transfer timing primary voltage (positive polarity) and the transfer timing secondary voltage (negative polarity). After step S102, the processing proceeds to step S110.

In step S110, the CPU 11 determines whether the transfer timing primary voltage acquired in step S102 is equal to or higher than the predetermined reference voltage (for example, 1000 V). When it is determined YES in step S110, the processing proceeds to step S112, and the control of Case 1 described above starts. On the other hand, when it is determined NO in step S110, the processing proceeds to step S120.

In step S112, the CPU 11 adjusts the current to flow through the secondary transfer unit 34 while acquiring the voltages of the primary transfer unit 33 and the secondary transfer unit 34, and makes a current having the same polarity (positive polarity) as the primary transfer unit 33 and causing the application of a voltage equal to that applied to the primary transfer unit 33 flow through the secondary transfer unit 34. After step S112, the processing proceeds to step S114.

In step S114, the CPU 11 adjusts the current to flow through the secondary transfer unit 34 while acquiring the voltages of the primary transfer unit 33 and the secondary transfer unit 34, and makes a current (transfer timing secondary current) causing application of the transfer timing secondary voltage, which is a voltage of an opposite polarity (negative polarity) to that applied to the primary transfer unit 33, flow through the secondary transfer unit 34. After step S114, the processing proceeds to step S116.

In step S116, the CPU 11 calculates the correction coefficient K1 based on the voltage value of the primary transfer unit 33 in the first state acquired in step S112 and the voltage measurement value of the primary transfer unit 33 in the second state acquired in step S114. After step S116, the processing proceeds to step S118.

In step S118, the CPU 11 adjusts the current to flow through the primary transfer unit 33 using the correction coefficient KI calculated in step S116. Specifically, a current obtained by multiplying the primary current setting value caused to flow in step S102 by the correction coefficient Kl is caused to flow through the primary transfer unit 33 as the corrected transfer timing primary current. After step S118, the process proceeds to step S150.

In step S120, the CPU 11 adjusts the current to flow through the secondary transfer unit 34 while acquiring the voltages of the primary transfer unit 33 and the secondary transfer unit 34, and makes a current causing application of a voltage equal to a predetermined reference voltage flow through the secondary transfer unit 34. After step S120, the processing proceeds to step S122.

In step S122, the CPU 11 determines whether the difference between the reference voltage and the voltage of the primary transfer unit acquired in step S120 is equal to or lower than the predetermined threshold (for example, 500 V). When it is determined YES in step S122, the processing proceeds to step S124, and the control of Case 2 described above starts. On the other hand, when it is determined NO in step S122, the processing proceeds to step S130.

In step S124, the CPU 11 adjusts the current to flow through the secondary transfer unit 34 while acquiring the voltages of the primary transfer unit 33 and the secondary transfer unit 34, and makes a current (transfer timing secondary current) causing application of the transfer timing secondary voltage, which is a voltage of an opposite polarity (negative polarity) to that applied to the primary transfer unit 33, flow through the secondary transfer unit 34. After step S124, the processing proceeds to step S126.

In step S126, the CPU 11 calculates the correction coefficient K2 based on the voltage value of the primary transfer unit 33 in the first state acquired in step S120 and the voltage measurement value of the primary transfer unit 33 in the second state acquired in step S124. After step S126, the processing proceeds to step S128.

In step S128, the CPU 11 adjusts the current to flow through the primary transfer unit 33 using the correction coefficient K2 calculated in step S126. Specifically, a current obtained by multiplying the primary current setting value caused to flow in step S102 by the correction coefficient K2 is caused to flow through the primary transfer unit 33 as the corrected transfer timing primary current. After step S128, the processing proceeds to step S150.

In step S130, the CPU 11 determines whether a job involving image transfer onto the sheet P has been received. When it is determined YES in step S130, the processing proceeds to step S132, and the control of Case 3 described above starts. When it is determined YES in step S130, the processing proceeds to step S142, and the control of Case 4 described above starts.

In step S132, the CPU 11 adjusts the current to flow through the primary transfer unit 33 while acquiring the voltages of the primary transfer unit 33 and the secondary transfer unit 34, and makes a current (reference voltage) causing application of a voltage equal to that applied to the secondary transfer unit 34 flow through the primary transfer unit 33. After step S132, the processing proceeds to step S134.

In step S134, the CPU 11 adjusts the current to flow through the secondary transfer unit 34 while acquiring the voltages of the primary transfer unit 33 and the secondary transfer unit 34, and makes a current (transfer timing secondary current) causing application of the transfer timing secondary voltage, which is a voltage of an opposite polarity (negative polarity) to that applied to the primary transfer unit 33, flow through the secondary transfer unit 34. After step S134, the processing proceeds to step S136.

In step S136, the CPU 11 calculates the correction coefficient K3 based on the voltage value of the primary transfer unit 33 in the first state acquired in step S132 and the voltage measurement value of the primary transfer unit 33 in the second state acquired in step S134. After step S136, the processing proceeds to step S138.

In step S138, the CPU 11 adjusts the current to flow through the primary transfer unit 33 using the correction coefficient K3 calculated in step S136. Specifically, a current obtained by multiplying the primary current setting value caused to flow in step S102 by the correction coefficient K3 is caused to flow through the primary transfer unit 33 as the corrected transfer timing primary current. After step S138, the processing proceeds to step S150.

In step S142, the CPU 11 adjusts the current to flow through the secondary transfer unit 34 while acquiring the voltages of the primary transfer unit 33 and the secondary transfer unit 34, and makes a current causing application of a voltage equal to that applied to the primary transfer unit 33 flow through the secondary transfer unit 34. After step S142, the processing proceeds to step S144.

In step S144, the CPU 11 adjusts the current to flow through the secondary transfer unit 34 while acquiring the voltages of the primary transfer unit 33 and the secondary transfer unit 34, and makes a current (transfer timing secondary current) causing application of the transfer timing secondary voltage, which is a voltage of an opposite polarity (negative polarity) to that applied to the primary transfer unit 33, flow through the secondary transfer unit 34. After step S144, the processing proceeds to step S146.

In step S146, the CPU 11 calculates the correction coefficient K4 based on the voltage value of the primary transfer unit 33 in the first state acquired in step S142 and the voltage measurement value of the primary transfer unit 33 in the second state acquired in step S144. After step S146, the processing proceeds to step S147.

In step S147, the CPU 11 makes a current causing application of a voltage equal to or higher than the reference voltage flow through the secondary transfer unit 34, and controls the cleaning device 62 to clean the secondary transfer unit 34. After step S147, the processing proceeds to step S148.

In step S148, the CPU 11 adjusts the current to flow through the primary transfer unit 33 using the correction coefficient K4 calculated in step S146. Specifically, a current obtained by multiplying the primary current setting value caused to flow in step S102 by the correction coefficient K4 is caused to flow through the primary transfer unit 33 as the corrected transfer timing primary current. Further, the CPU 11 adjusts the current to flow through the secondary transfer unit 34, and makes the transfer timing secondary current flow through the secondary transfer unit 34. After step S148, the processing proceeds to step S150.

In step S150, the CPU 11 controls the image forming unit 12 and the like to execute the instructed print job. When the print job ends, the current adjustment processing ends.

### Operations and Effects

In the above-described exemplary embodiment, the correction coefficient is calculated based on the voltage measurement value of the primary transfer unit in each of the first state in which the positive voltage is applied to the secondary transfer unit and the second state in which the negative voltage is applied to the secondary transfer unit. Then, using the correction coefficient, the transfer timing primary current to flow through the primary transfer unit during image transfer onto the image recording medium is adjusted.

This makes it possible to compensate for the current flowing from the primary transfer unit 33 to the secondary transfer unit 34 via the intermediate transfer belt 31 during image transfer onto the image recording medium.

In Cases 1, 3, and 4 of the above-described exemplary embodiment, in the first state, a current causing application of an equal voltage to the primary transfer unit 33 and the secondary transfer unit 34 is caused to flow. Therefore, in the first state, current interference is unlikely to occur between the primary transfer unit 33 and the secondary transfer unit 34. As a result, the accuracy of the correction coefficient is higher than in the case where different voltages are applied to the primary transfer unit 33 and the secondary transfer unit 34.

In Cases 1, 2, and 4 of the above-described exemplary embodiment, in the first state, the transfer timing primary current is caused to flow through the primary transfer unit 33. For this reason, the correction coefficients K1, K2, and K4 are calculated based on the voltage at the time when the transfer timing primary current flows. As a result, the accuracy of the correction coefficient is higher than in the case where the correction coefficient is calculated while making a current different from the transfer timing primary current flow through the primary transfer unit 33.

In Cases 1 and 4 of the above-described exemplary embodiment, in the first state, the current flowing through the secondary transfer unit 34 is adjusted, and a current causing application of a voltage equal to that applied to the primary transfer unit 33 is caused to flow through the secondary transfer unit 34. Therefore, in the first state, current interference is unlikely to occur between the primary transfer unit 33 and the secondary transfer unit 34. As a result, the accuracy of the correction coefficient is higher than in the case where different voltages are applied to the primary transfer unit 33 and the secondary transfer unit 34.

In Case 1 of the above-described exemplary embodiment, the voltage at the time when the transfer timing primary current flows through the primary transfer unit 33 is equal to or higher than the predetermined reference voltage. Further, in the first state, a current causing application of a voltage equal to that applied to the primary transfer unit 33 is caused to flow through the secondary transfer unit 34. That is, a voltage equal to or higher than the reference voltage is applied to the secondary transfer unit 34. As a result, the cleaning of the secondary transfer unit 34, which is required when the voltage applied to the secondary transfer unit 34 is lower than the reference voltage, is no longer required.

Further, in the first state, the transfer timing primary current is caused to flow through the primary transfer unit 33. As a result, the accuracy of the correction coefficient is higher than in the case where the correction coefficient is calculated with a current different from the transfer timing primary current flowing through the primary transfer unit 33.

In Case 3 of the above-described exemplary embodiment, in the first state, the current causing application of the reference voltage equal to that applied to the secondary transfer unit 34 is caused to flow through the primary transfer unit 33.

Therefore, in the first state, current interference is unlikely to occur between the primary transfer unit 33 and the secondary transfer unit 34. As a result, the accuracy of the correction coefficient is higher than in the case where different voltages are applied to the primary transfer unit 33 and the secondary transfer unit 34. Further, the cleaning of the secondary transfer unit 34, which is required in the case where the voltage applied to the secondary transfer unit 34 is lower than the reference voltage, is no longer required.

In Case 4 of the above-described exemplary embodiment, in the first state, a current causing application of a reference voltage equal to that applied to the primary transfer unit 33 is caused to flow through the secondary transfer unit 34. Further, in the first state, the transfer timing primary current is caused to flow through the primary transfer unit 33.

Therefore, in the first state, current interference is unlikely to occur between the primary transfer unit 33 and the secondary transfer unit 34. As a result, the accuracy of the correction coefficient is higher than in the case where different voltages are applied to the primary transfer unit 33 and the secondary transfer unit 34. Furthermore, the accuracy of the correction coefficient is higher than in the case where the correction coefficient is calculated with a current different from the transfer timing primary current flowing through the primary transfer unit 33.

Case 4 of the above-described exemplary embodiment is executed when a subsequent job involving image transfer onto the sheet P has not been received. As described above, when a plurality of jobs involving image transfer onto the sheet P are not instructed to be executed, even if a voltage lower than the reference voltage is applied to the secondary transfer unit 34 in the first state, the secondary transfer unit can be cleaned.

In Case 2 of the above-described exemplary embodiment, in the first state, the transfer timing primary current is caused to flow through the primary transfer unit 33, and the current causing application of the reference voltage is caused to flow through the secondary transfer unit 34. Thus, the cleaning of the secondary transfer unit 34, which is required in the case where the voltage applied to the secondary transfer unit 34 is lower than the reference voltage, is no longer required.

In the above-described exemplary embodiment, in the initial state before the first state and the second state, the voltage of the primary transfer unit is acquired with the transfer timing primary current flowing through the primary transfer unit 33. As a result, the voltage applied to the primary transfer unit 33 with the transfer timing primary current flowing through the primary transfer unit 33 can be recognized.

In the above-described exemplary embodiment, the correction coefficient is obtained based on the voltage measurement value of the primary transfer unit 33 closest to the secondary transfer unit 34 on the upstream side in the rotation direction of the intermediate transfer belt 31. As a result, the current flowing from the primary transfer unit 33 closest to the secondary transfer unit 34 to the secondary transfer unit 34 can be compensated.

### Other Exemplary Embodiments

In the above-described exemplary embodiment, in Case 4, after the correction coefficient K4 is calculated, the secondary transfer unit 34 is cleaned (step S147). However, exemplary embodiments of the present disclosure are not limited thereto. The primary current may be adjusted with such a cleaning step omitted.

Further, in the above-described exemplary embodiment, the control of Case 3 is executed when a subsequent job involving image transfer has been received. In addition, when a subsequent job involving image transfer has not been received, the control of Case 4 is executed. However, exemplary embodiments of the present disclosure are not limited thereto.

Which of the control of Case 3 and the control of Case 4 is executed when the difference between the transfer timing primary voltage and the reference voltage exceeds the threshold can be set in advance in the image forming apparatus 80A.

Further, in the above-described exemplary embodiment, the control of Case 2 is executed when the difference between the transfer timing primary voltage and the reference voltage does not exceed the threshold. Further, when the difference between the transfer timing primary voltage and the reference voltage exceeds the threshold, either the control of Case 3 or the control of Case 4 is executed. However, exemplary embodiments of the present disclosure are not limited thereto.

It is possible to set in advance in the image forming apparatus 80A which of the control of Case 2, the control of Case 3, and the control of Case 4 is executed when the transfer timing primary voltage is lower than the reference voltage. Further, in the above-described exemplary embodiment, the apparatus is assumed to support the plurality of cases illustrated in FIG. 4 but only some of the cases may be assumed to be supported, and thus some of the cases may be executed. Further, only a part of the processing in the flowcharts of FIGS. 5A and 5B may be executed. For example, some or all of the determination results in the respective steps such as step S110, step S122, and step S130 may be omitted. In particular, steps in which the results of determination can be anticipated in advance based on the characteristics of the apparatus or the like may be omitted.

Further, in the above-described exemplary embodiment, the transfer timing primary voltage is acquired in the initial state before the first state and the second state. However, exemplary embodiments of the present disclosure are not limited thereto. For example, the transfer timing primary voltage may be set in advance and used as a known value.

Further, in the above-described exemplary embodiment, the correction coefficient is calculated based on the voltage measurement value of the primary transfer unit 33 closest to the secondary transfer unit 34 on the upstream side in the rotation direction of the intermediate transfer belt 31. However, exemplary embodiments of the present disclosure are not limited thereto. For example, the correction coefficient may be calculated based on the voltage measurement value of the primary transfer unit 33 other than the primary transfer unit 33 closest to the secondary transfer unit 34.

In addition, in the above-described exemplary embodiment, for example, as a hardware structure of a processing unit that executes processing of each of the acquisition unit 11A, the determination unit 11B, the setting unit 11C, the calculation unit 11D, and the control unit 11E, various processors described below may be used. The various processors include, in addition to a central processing unit (CPU), which is a general-purpose processor that executes software (program) and functions as a processing unit as described above, a programmable logic device (PLD), which is a processor capable of changing a circuit configuration after a field programmable gate array (FPGA) or the lie is manufactured, a dedicated electric circuit, which is a processor having a circuit configuration designed as a dedicated circuit in order to perform specific processing such as an application specific integrated circuit (ASIC), and the like.

The processing unit may be constituted by one among these various processors, or may be constituted by a combination of the same kind or different kinds of two or more processors (for example, a combination of a plurality of FPGAs or a combination of a CPU and an FPGA). The processing unit may be configured by one processor. Some or all of these processors may be configured on a cloud. At least each processing described in the above-described exemplary embodiment may be executed by a processor on a cloud.

As a first example where the processing unit is configured by one processor, there is a mode in which one processor is configured by a combination of one or more CPUs and software, and the processor functions as the processing unit as represented by computers such as a client and a server. As a second example, there is a mode of using a processor that realizes the functions of the entire system including a processing unit by one integrated circuit (IC) chip as represented by a system-on-chip (SoC) or the like. In this way, the processing unit is configured using one or more of the various processors as a hardware structure.

Further, as a hardware structure of these various processors, more specifically, an electric circuit (circuitry) in which circuit elements such as semiconductor elements are combined can be used. As described above, the present disclosure can be implemented in various modes.

### APPENDIX

### (((1)))

An information processing system comprising:
at least one processor configured to:
calculate a correction coefficient based on a voltage measurement value of a primary transfer unit in a first state in which voltages of same polarity are applied to the primary transfer unit and a secondary transfer unit in contact with an intermediate transfer belt of an image forming apparatus, and a voltage measurement value of the primary transfer unit in a second state in which voltages of opposite polarities are applied to the primary transfer unit and the secondary transfer unit, with a setting to make a same current as in the first state flow through the primary transfer unit; and
adjust, using the correction coefficient, a transfer timing primary current to flow through the primary transfer unit when an image is transferred to an image recording medium.

### (((2)))

The information processing system according to (((1))), wherein the processor is configured to make, in the first state, a current causing application of an equal voltage to the primary transfer unit and the secondary transfer unit flow.

### (((3)))

The information processing system according to (((1))) or (((2))), wherein the processor is configured to make, in the first state, the transfer timing primary current before the adjustment flow through the primary transfer unit.

### (((4)))

The information processing system according to any one of (((1)) to ((3))), wherein the processor is configured to adjust, in the first state, a current flowing through the secondary transfer unit, and apply a voltage equal to a voltage applied to the primary transfer unit, to the secondary transfer unit.

### (((5)))

The information processing system according to any one of (((1))) to (((4))), wherein the processor is configured to, when a voltage at time when the transfer timing primary current flows through the primary transfer unit is equal to or higher than a predetermined reference voltage, adjust, in the first state, a current flowing through the secondary transfer unit, and apply a voltage equal to a voltage applied to the primary transfer unit, to the secondary transfer unit.

### (((6)))

The information processing system according to (((1))) or (((3))), wherein the processor is configured to, when a voltage at time when the transfer timing primary current flows through the primary transfer unit is lower than a predetermined reference voltage, make, in the first state, the transfer timing primary current flow through the primary transfer unit, and make a current causing application of the reference voltage flow through the secondary transfer unit.

### (((7)))

The information processing system according to (((1))) or (((2))), wherein the processor is configured to, when a voltage at time when the transfer timing primary current flows through the primary transfer unit is lower than a predetermined reference voltage, adjust, in the first state, a current flowing through the primary transfer unit, and apply a voltage that is the reference voltage and is equal to a voltage applied to the secondary transfer unit, to the primary transfer unit.

### (((8)))

The information processing system according to any one of (((1))) to (((4))), wherein the processor is configured to:
when a voltage at time when the transfer timing primary current flows through the primary transfer unit is lower than a predetermined reference voltage, adjust, in the first state, a current flowing through the secondary transfer unit, and apply a voltage equal to a voltage applied to the primary transfer unit, to the secondary transfer unit; and
after the correction coefficient is calculated, adjust the current flowing through the secondary transfer unit, and apply a voltage equal to or higher than the reference voltage to the secondary transfer unit to clean the secondary transfer unit.

### (((9)))

The information processing system according to (((7))), wherein the processor is configured to:
when a subsequent job involving image transfer onto the image recording medium is received, adjust, in the first state, a current flowing through the primary transfer unit, and apply a voltage that is the reference voltage and is equal to a voltage applied to the secondary transfer unit, to the primary transfer unit; and
when the subsequent job involving the image transfer onto the image recording medium is not received, adjust, in the first state, a current flowing through the secondary transfer unit, and apply a voltage equal to a voltage applied to the primary transfer unit, to the secondary transfer unit, and after the correction coefficient is calculated, adjust the current flowing through the secondary transfer unit, and apply a voltage equal to or higher than the reference voltage to the secondary transfer unit to clean the secondary transfer unit.

### (((10)))

The information processing system according to (((2))), wherein the processor is configured to, when a difference between a predetermined reference voltage and a voltage at time when the transfer timing primary current flows through the primary transfer unit exceeds a threshold, make, in the first state, a current causing application of an equal voltage to the primary transfer unit and the secondary transfer unit flow.

### (((11)))

The information processing system according to any one of (((1))) to (((10))), wherein the processor is configured to, before the first state and the second state, make the transfer timing primary current flow through the primary transfer unit, and acquire a voltage of the primary transfer unit.

### (((12)))

The information processing system according to any one of (((1))) to (((11))), wherein the processor is configured to, when there are a plurality of the primary transfer units in contact with the intermediate transfer belt, calculate the correction coefficient based on the voltage measurement value of one of the primary transfer units closest to the secondary transfer unit on an upstream side in a rotation direction of the intermediate transfer belt.

### (((13)))

A program causing a computer to execute a process for information processing, the process comprising:
calculating a correction coefficient based on a voltage measurement value of a primary transfer unit in a first state in which voltages of same polarity are applied to the primary transfer unit and a secondary transfer unit in contact with an intermediate transfer belt of an image forming apparatus, and a voltage measurement value of the primary transfer unit in a second state in which voltages of opposite polarities are applied to the primary transfer unit and the secondary transfer unit, with a setting to make same current as in the first state flow through the primary transfer unit; and
adjusting, using the correction coefficient, a transfer timing primary current to flow through the primary transfer unit when an image is transferred to an image recording medium.

What is claimed is:

1. An information processing system comprising:
at least one processor configured to:
calculate a correction coefficient based on a voltage measurement value of a primary transfer unit in a first state in which voltages of same polarity are applied to the primary transfer unit and a secondary transfer unit in contact with an intermediate transfer belt of an image forming apparatus, and a voltage measurement value of the primary transfer unit in a second state in which voltages of opposite polarities are applied to the primary transfer unit and the secondary transfer unit, with a setting to make a same current as in the first state flow through the primary transfer unit; and
adjust, using the correction coefficient, a transfer timing primary current to flow through the primary transfer unit when an image is transferred to an image recording medium.

2. The information processing system according to claim 1, wherein the processor is configured to make, in the first state, a current causing application of an equal voltage to the primary transfer unit and the secondary transfer unit flow.

3. The information processing system according to claim 1, wherein the processor is configured to make, in the first state, the transfer timing primary current before the adjustment flow through the primary transfer unit.

4. The information processing system according to claim 2, wherein the processor is configured to adjust, in the first state, a current flowing through the secondary transfer unit, and apply a voltage equal to a voltage applied to the primary transfer unit, to the secondary transfer unit.

5. The information processing system according to claim 2, wherein the processor is configured to, when a voltage at time when the transfer timing primary current flows through the primary transfer unit is equal to or higher than a predetermined reference voltage, adjust, in the first state, a current flowing through the secondary transfer unit, and apply a voltage equal to a voltage applied to the primary transfer unit, to the secondary transfer unit.

6. The information processing system according to claim 1, wherein the processor is configured to, when a voltage at time when the transfer timing primary current flows through the primary transfer unit is lower than a predetermined reference voltage, make, in the first state, the transfer timing primary current flow through the primary transfer unit, and make a current causing application of the reference voltage flow through the secondary transfer unit.

7. The information processing system according to claim 2, wherein the processor is configured to, when a voltage at time when the transfer timing primary current flows through the primary transfer unit is lower than a predetermined reference voltage, adjust, in the first state, a current flowing through the primary transfer unit, and apply a voltage that is the reference voltage and is equal to a voltage applied to the secondary transfer unit, to the primary transfer unit.

8. The information processing system according to claim 2, wherein the processor is configured to:
when a voltage at time when the transfer timing primary current flows through the primary transfer unit is lower than a predetermined reference voltage, adjust, in the first state, a current flowing through the secondary transfer unit, and apply a voltage equal to a voltage applied to the primary transfer unit, to the secondary transfer unit; and
after the correction coefficient is calculated, adjust the current flowing through the secondary transfer unit, and apply a voltage equal to or higher than the reference voltage to the secondary transfer unit to clean the secondary transfer unit.

9. The information processing system according to claim 7, wherein the processor is configured to:
when a subsequent job involving image transfer onto the image recording medium is received, adjust, in the first state, a current flowing through the primary transfer unit, and apply a voltage that is the reference voltage and is equal to a voltage applied to the secondary transfer unit, to the primary transfer unit; and
when the subsequent job involving the image transfer onto the image recording medium is not received, adjust, in the first state, a current flowing through the secondary transfer unit, and apply a voltage equal to a voltage applied to the primary transfer unit, to the secondary transfer unit, and after the correction coefficient is calculated, adjust the current flowing through the secondary transfer unit, and apply a voltage equal to or higher than the reference voltage to the secondary transfer unit to clean the secondary transfer unit.

10. The information processing system according to claim 2, wherein the processor is configured to, when a difference between a predetermined reference voltage and a voltage at time when the transfer timing primary current flows through the primary transfer unit exceeds a threshold, make, in the first state, a current causing application of an equal voltage to the primary transfer unit and the secondary transfer unit flow.

11. The information processing system according to claim 1, wherein the processor is configured to, before the first state and the second state, make the transfer timing primary current flow through the primary transfer unit, and acquire a voltage of the primary transfer unit.

12. The information processing system according to claim 1, wherein the processor is configured to, when there are a plurality of the primary transfer units in contact with the intermediate transfer belt, calculate the correction coefficient based on the voltage measurement value of one of the primary transfer units closest to the secondary transfer unit on an upstream side in a rotation direction of the intermediate transfer belt.

13. A non-transitory computer readable medium storing a program causing a computer to execute a process for information processing, the process comprising:
calculating a correction coefficient based on a voltage measurement value of a primary transfer unit in a first state in which voltages of same polarity are applied to the primary transfer unit and a secondary transfer unit in contact with an intermediate transfer belt of an image forming apparatus, and a voltage measurement value of the primary transfer unit in a second state in which voltages of opposite polarities are applied to the primary transfer unit and the secondary transfer unit, with a setting to make same current as in the first state flow through the primary transfer unit; and
adjusting, using the correction coefficient, a transfer timing primary current to flow through the primary transfer unit when an image is transferred to an image recording medium.
